(19) United States
(12) Patent Application Publication
(10) Pub. No.: US 2016/0171004 A1
(43) Pub. Date: Jun. 16, 2016

(54) METHOD AND SYSTEM FOR IMPROVING THE LOCATION PRECISION OF AN OBJECT TAKEN IN A GEO-TAGGED PHOTO

(71) Applicant: Pitney Bowes Inc., Danbury, CT (US)

(72) Inventors: Jun ZHANG, Shelton, CT (US); Hongping LIANG, Bethany, CT (US); Robert A. CORDERY, Monroe, CT (US); Nathaniel COOPER, Long Beach, NY (US); Zhenan HONG, Milford, CT (US)

(73) Assignee: PITNEY BOWES INC., Danbury, CT (US)

(21) Appl. No.: 14/567,250

(22) Filed: Dec. 11, 2014

(51) Int. Cl. G06F 17/30; G06T 7/60; G06T 7/00

(52) U.S. Cl. CPC G06F 17/3087; G06F 17/30241; G06F 17/30271; G06F 17/30256; G06T 7/004; G06T 7/608

(57) ABSTRACT

A system and method that improves the location precision of the object taken in a geo-tagged photo. When a photo is taken of an object, the distance to the object in the photo is determined. The angle between magnetic north and the direction the mobile phone is facing is also determined. Using this information along with the location coordinates of the mobile phone, the coordinates of the object's location can be determined.

### FIELD OF THE INVENTION

The present invention relates to location-based services, and in particular to a method and system for improving the location precision of an object taken in a geo-tagged photo.

### BACKGROUND OF THE INVENTION

Location-based service (LBS) providers allow a business to provide a location-based service, e.g., coupon, advertisements, brochures, information, etc., to potential customers that are both timely and relevant. One type of a location-based service is in the real-estate market. A potential real-estate purchaser can use a mobile phone to take a picture of the real-estate they are interested in to obtain detailed information about the property. The picture taken by the mobile phone includes a geo-tag, which is information that identifies the user's current location, usually based on longitude and latitude. The picture is sent to a remote server, which uses the embedded location information to search a database and retrieve the relevant real-estate information based on the users location. Such information could include, for example, current price, selling history, contact information about the owner or agent, specific details about the property, etc.

There are some problems, however, with such systems. For example, as illustrated in FIG. 1, a user 10 desires to obtain information about house 14. The user 10 takes a picture using a mobile phone 12 of the house 14. The photo is geo-tagged with the user's location (typically longitude/latitude information), identified as point A. When the photo is sent to the server 20, via the network 24, it is the user's location (point A) that is used to conduct a nearest spatial search of the database 22 for relevant information. Since the latitude/longitude information of point A is closer to house 16, it is very likely that the information for house 16 will be returned to the user 10 instead of the information for house 14 as actually desired by the user 10. Thus, the difference between the actual location of the user taking the photo and the location of the house in the photo could cause the wrong information to be returned to the user.

### SUMMARY OF THE INVENTION

The present invention alleviates the problems described above by providing a system and method that improves the location precision of the object taken in a geo-tagged photo.

In accordance with embodiments of the present invention, when a photo is taken of an object, the distance to the object in the photo is determined. The angle between magnetic north and the direction the mobile phone is facing is also determined. Using this information along with the location coordinates of the mobile phone, the coordinates of the object's location can be determined. The determined coordinates of the object are then used to conduct the nearest spatial search of the database for relevant information. Because the coordinates of the object are used instead of the coordinates of the user, the likelihood of returning the proper information is significantly increased.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 as a block diagram illustrating operation of a conventional location based service in the real estate industry;

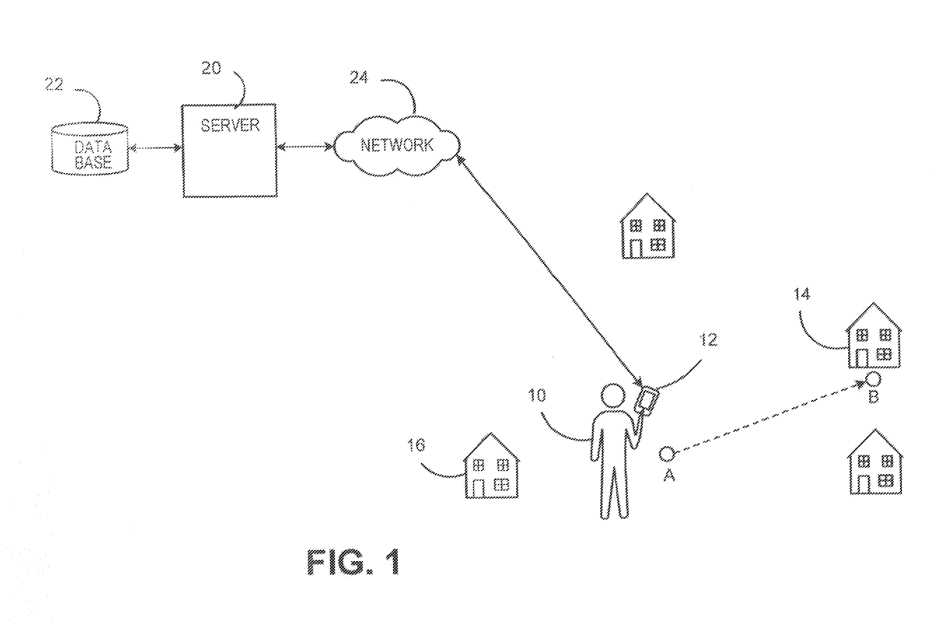

FIG. 2 is a block diagram illustrating operation of a location based service according to an embodiment of the present invention;

FIG. 3 is flow chart illustrating the processing performed to determine the location of an object in a photo according to an embodiment of the present invention; and

FIG. 4 is a block diagram illustrating operation of a location based service according to another embodiment of the present invention.

### DETAILED DESCRIPTION OF THE PRESENT INVENTION

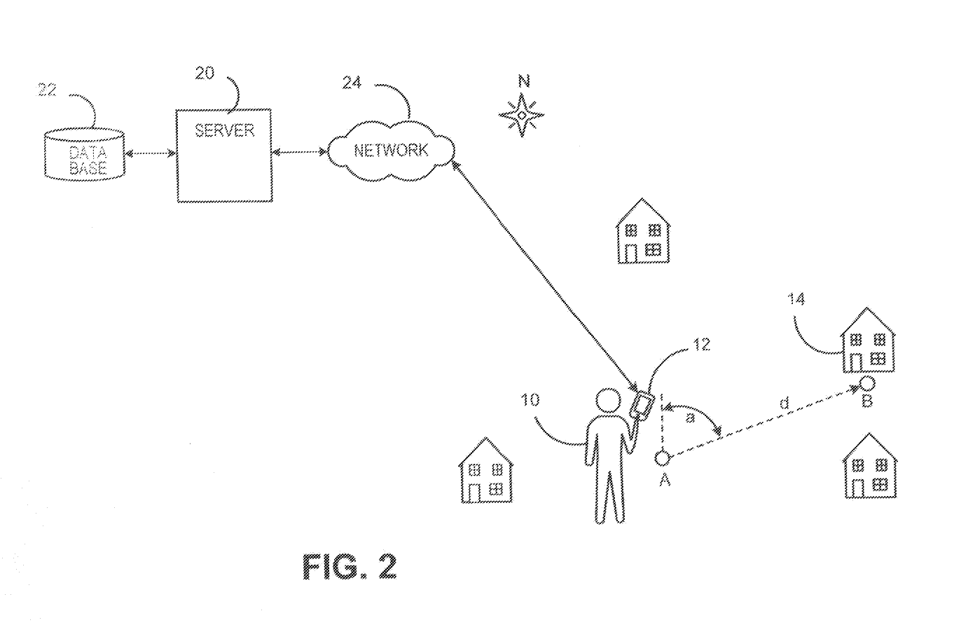

In describing the present invention, reference is made to the drawings, wherein there is seen in FIG. 2 in block diagram form operation of a location based service according to an embodiment of the present invention. While the following description will be provided in the context of a location based service for the real estate industry, it should be understood that the present invention is not so limited and can be used in any application. Referring now to FIG. 2, a server 20 is operated by a first party, which may be, for example, a business, organization, or any other type of entity. Server 20 is coupled to a database 22, which may be any suitable type of memory device utilized to store information. Such information can include, for example, information related to real estate property listings, such as current price, selling history, contact information about the owner or agent, specific details about the property, etc. Server 20 is coupled to a network 24, such as, for example the Internet, a wireless cellular network, or any other type of suitable network, which allows it to communicate with a mobile telephone 12. Mobile telephone 12 can be any type of mobile telephone as are well known in the art. Server 20 may be a mainframe or the like that includes at least one processing device (not shown). Server 20 may be specially constructed for the required purposes, or it may comprise a general purpose computer selectively activated or reconfigured by a computer program stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the processing device. One of ordinary skill in the art would be familiar with the general components of a computing system upon which the method of the present invention may be performed.

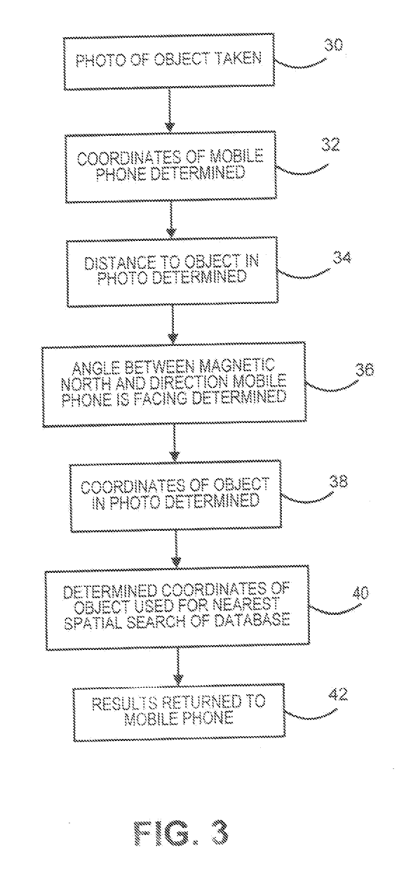

The processing performed by the mobile telephone 12 and server 20 allows a user 10 to provide location information about real estate that user is interested in and the server 20 will search the database 22 for information related to that real estate to return to the mobile phone 12. Suppose, for example the user 10 is interested in house 14. The user 10 will activate a software application that resides on the mobile phone 12 to enable the process. Using the mobile phone 12. the user 10 takes a picture of the house. According to the present invention, the location information of the object of the photo, i.e., house 14, is determined and used, instead of the location information of the mobile phone 12, by the server 20 to search the database 22 for relevant information. FIG. 3 is flow chart illustrating the processing performed to determine the location of the object, e.g., house 14, in a photo according to an embodiment of the present invention. The processing as described in FIG. 3 can be performed by the mobile phone 12, the server 20, or in some combination of the two. In step 30, the user 10 uses the camera of a mobile phone 12 to take a picture of the house 14. It should be understood that while the device milked by the user 10 is described as a mobile phone 12, any other type of device that has the ability to capture photos and perform, the processing described herein can be used, such as, for example, a tablet or the like. In step 32, the latitude/longitude coordinates (X_{A}, Y_{A}) of the mobile phone 12 (point A in FIG. 2) are determined. Such determination can be made using, for example, the global positioning system (GPS) receiver that is provided in many of the mobile phones currently on the market or cell phone tower triangulation measurements. In step 34, the distance d (see FIG. 2) between the mobile phone 12 and the object in the photo, i.e., house 14, is determined. This can be done using related EXIF (Exchangeable Image File Format) Data that is recorded for each photo taken by the camera. Such data can include a range of settings such as subject distance, ISO speed, shutter speed, aperture, white balance, camera model and make, date and time, lens type, focal length and more. For those cameras that don't include the subject distance, the distance to the object can be calculated using other EXIF Data, such as focal length, image size, sensor size and an estimated height of the object. An estimated height of the house 14 can be determined based on the neighborhood the house 14 is located in, as most houses in the same area are of similar construction and would have roughly a similar height. Alternatively, the height of the house 14 could be estimated based on some simple feature extraction of edges of windows, roof doors and number of floors. The perspective distortion can be calculated assuming the walls, doors and windows vertical edges are all parallel. This allows an estimate of the distance from the height estimate by image processing. Alternatively, the distance to the house can be determined using the range-finding technology built into the mobile phone, which utilize laser technology to emit signals that reflect off of objects and determine the distance to an object based on the time required for a return signal to be received.

In step 36, the angle a (see FIG. 2) between the direction the mobile phone 12 is facing and magnetic north (labeled N in FIG. 2) is determined. This can be determined using magnetometers that are built into many of the mobile phones on the market today. Magnetic sensors located within the mobile phone 12 determine the direction of magnetic north, and from that the angle a can be determined. Alternatively, on days with some sun, the direction of illumination can be estimated from shadows in the image and then using the time, the orientation of the house and the mobile phone 12 can be estimated. In step 38, the latitude/longitude (X, Y) coordinates of the object in the photo, i.e., house 14 at point B in FIG. 2 (X_{B}, Y_{B}), is calculated using the information obtained in steps 32-36 and the following formulae:

X_{B}=X_{A}+d*sin(a) (Eq. 1)

Y_{B}=Y_{A}+d*cos(a) (Eq. 2)

The calculation, of (X_{B}, Y_{B}) can be done either by the mobile phone 12 and the results sent to the server 20 (for example as embedded information in the photo data), or can be calculated by the server 20 based on the necessary information being provided by the mobile phone 12. Once the coordinates for house 14 are determined in step 38, then in step 40 those coordinates are used by the server 20 to conduct a nearest spatial search of the database 22. Because the coordinates being used for the search are the actual coordinates of the object in the photo, i.e., house 14, the likelihood of returning the proper information (information about house 14) instead of information about the house closest to the location from which the picture was taken is significantly increased. In step 42, the results (if found) from the database 22 are returned to the mobile phone 12 via the network 24.

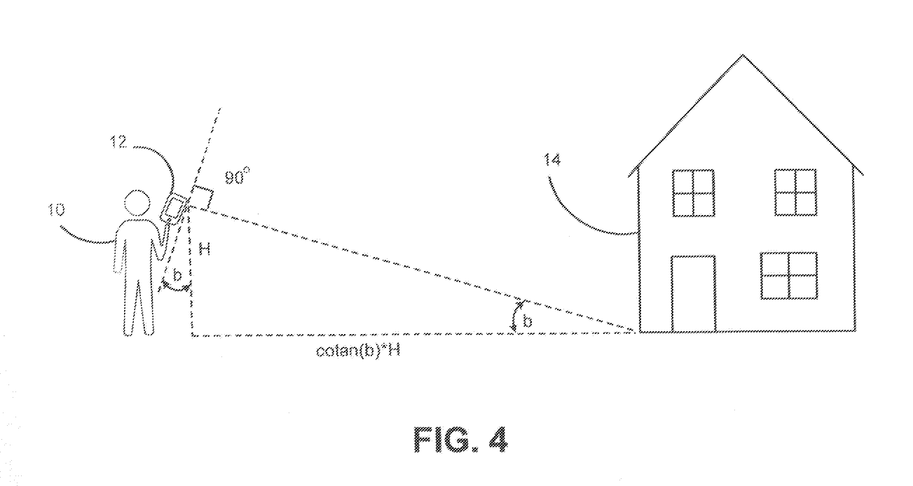

As described above, the distance to the object on the photo can be determined (step 34 in FIG. 3) using EXIF Data. For those phones with cameras that do not have such capability, the distance to the object can be determined using an alternative method. FIG. 4 illustrates in block diagram form how the distance to the object in the photo can be determined according to another embodiment of the present invention. As shown in FIG. 4, when the user 10 uses the application to take a picture of the house 14, the user will be instructed to point the mobile phone 12 towards the baseline of the house 14. Such instruction can be provided, for example, by an alignment mark provided on the screen of the phone with instructions to the user to align the mark with the base of the house when taking the picture. The angle b formed between the ground at the base of the house and the position of the mobile phone 12 can be determined using an accelerometer sensor built into many of the mobile phones currently on the market today. The distance to the house 14 can be determined using cotan(b)*H, where H is the height of the mobile phone 12. When taking pictures, most users hold the phone about 15 centimeters lower than their height, which means the approximate value of H is the user's height minus 15 centimeters. So the distance d to the house can be reasonably estimated by the equation:

d=cotan(b)*(height of user−0.15) meters (Eq. 3)

The user can enter their height into the mobile phone 12 based on a prompt each time a photo is taken using the software application or it can be entered once by the user and stored within the software application for retrieval as necessary. Once the distance d is found, it can be used in the processing described above with respect to FIG. 3 to determine the coordinates of the object in the photo, e.g., house 14.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for determining latitude and longitude coordinates of an object in a photo taken by a device, the method comprising:
determining, by the device, longitude and latitude coordinates (X_{A}*Y_{A}) of the device when the photo was taken;
determining, by the device, a distance d from the device to the object when the photo was taken;
determining, by the device, an angle a between magnetic north and a direction the device is facing when the photo was taken;
calculating, by the device or a remote server, a longitude and latitude (X_{B}, Y_{B}) of the object in the photo based on the longitude and latitude coordinates (X_{A}, Y_{A}) of the device, the distance d from the device to the object, and the angle a between magnetic north and the direction the device is facing when the photo is taken.

2. The method of claim 1, wherein the device is a mobile phone.

3. The method of claim 2, wherein determining longitude and latitude coordinates (X_{A}, Y_{A}) of the device when the photo was taken further comprises:
using cell phone tower triangulation to determine the longitude and latitude coordinates (X_{A}, Y_{A}) of the mobile phone when the photo was taken.

4. The method of claim 1, wherein determining longitude and latitude coordinates (X_{A}, Y_{A}) of the device when the photo was taken further comprises:
using a global positioning receiver in the device to determine the longitude and latitude coordinates (X_{A}, Y_{A}) of the device when the photo was taken.

5. The method of claim 1, wherein determining a distance d from the device to the object when the photo was taken further comprises:
using EXIF data to determine the distance.

6. The method of claim 1, wherein determining an angle a between magnetic north and a direction the device is facing when the photo was taken further comprises:
using a magnetometer built into the device.

7. The method of claim 1, wherein calculating a longitude and latitude (X_{B}, Y_{B}) of the object in the photo further comprises:
calculating the longitude X_{B} as X_{A}+d*sin(a); and
calculating the latitude Y_{b} as Y_{A}+d*cos(a).

8. The method of claim 1, wherein determining a distance d from the device to the object when the photo was taken further comprises:
determining an angle b formed between a base of the object and a position of the device using an accelerometer sensor built into the device;
determining a height H of the device based on a height of a user holding the device when the photo is taken; and
determining the distance d as cotan(b)*H.

9. A method for returning information related to house that is stored in a database based on a location of the house that is determined using a photo of the house taken by a device, the method, comprising:
determining, by the device, longitude and latitude coordinates (X_{A}, Y_{A}) of the device when the photo was taken;
determining, by the device, a distance d from the device to the house when the photo was taken;
determining, by the device, an angle a between magnetic north and a direction the device is facing when the photo was taken;
calculating, by the device or a remote server, a longitude and latitude (X_{B}, Y_{B}) of the house in the photo based on the longitude and latitude coordinates (X_{A}, Y_{A}) of the device, the distance d from the device to the house, and the angle a between magnetic north and the direction the device is facing when the photo is taken;
searching, by the remote server, the database using the calculated longitude and latitude (X_{B}, Y_{B}) of the house for information related to the house; and
returning, by the remote server to the device, information related to the house from the database found when using the calculated longitude and latitude (X_{B}, Y_{B}) of the house.

10. The method of claim 9, wherein the device is a mobile phone.

11. The method of claim 10, wherein determining longitude and latitude coordinates (X_{A}, Y_{A}) of the device when the photo was taken further comprises:
using cell phone tower triangulation to determine the longitude and latitude coordinates (X_{A}, Y_{A}) of the mobile phone when the photo was taken.

12. The method of claim 9, wherein determining longitude and latitude coordinates (X_{A}, Y_{A}) of the device when the photo was taken further comprises:
using a global positioning receiver in the device to determine the longitude and latitude coordinates (X_{A}, Y_{A}) of the device when the photo was taken.

13. The method of claim 9, wherein determining a distance d from the device to the house when the photo was taken further comprises:
using EXIF data to determine the distance.

14. The method of claim 9, wherein determining an angle a between magnetic north and a direction the device is facing when the photo was taken further comprises:
using a magnetometer built into the device.

15. The method of claim 1, wherein calculating a longitude and latitude (X_{B}, Y_{B}) of the house in the photo further comprises:
calculating the longitude X_{B} as X_{A}+d*sin(a); and
calculating the latitude Y_{B} as Y_{A}+d*cos(a).
